(19) United States
(12) Patent Application Publication
(10) Pub. No.: US 2025/0199119 A1
(43) Pub. Date: Jun. 19, 2025

(54) DISPLACEMENT MONITORING METHOD BASED ON ELLIPTICAL TRAJECTORY CALIBRATION AND MODIFIED PRINCIPAL COMPONENT ANALYSIS

(71) Applicant: NATIONAL SUN YAT-SEN UNIVERSITY, Kaohsiung (TW)

(72) Inventors: Fu-Kang Wang, Kaohsiung (TW); Ji-Xun Zhong, Kaohsiung (TW); Ju-Yin Shih, Kaohsiung (TW)

(21) Appl. No.: 18/766,850

(22) Filed: Jul. 9, 2024

(30) Foreign Application Priority Data
Dec. 19, 2023 (TW) 112149604

(51) Int. Cl. G01S 7/40; G01S 13/02

(52) U.S. Cl. CPC G01S 7/40; G01S 13/02

(57) ABSTRACT

In a displacement monitoring method based on elliptical trajectory calibration and modified principal component analysis, four channels are compressed into two set signals through linear combination to solve null point issue in Doppler radar and cancel clutter effect. The two sets linear combined signals make two tilted elliptical trajectories which can be calibrated for DC offset, amplitude imbalance and phase imbalance using simple computation. Due to the elliptical trajectories are mirror symmetric tilt ellipses, the residual clutter can be cancelled to recover a clear Doppler phase after demodulation and combination.

### CROSS-REFERENCE TO RELATED APPLICATIONS

This application claims priority to R.O.C patent application No. 112149604 filed Dec. 19, 2023, the disclosure of which is hereby incorporated by reference in its entirety.

### FIELD OF THE INVENTION

This invention relates to a displacement monitoring method, and more particularly to a displacement monitoring method based on elliptical trajectory calibration and modified principal component analysis.

### BACKGROUND OF THE INVENTION

Continuous-wave (CW) radar is widely used in displacement monitoring, and a common method employed to solve the null point issue in CW radar is the use of two channels with in-phase (I) and quadrature (Q) phase signals. However, DC offset and clutter in the environment may cause distortion of phase demodulated result and further cause displacement monitoring error. In previous study, IQ signals are calibrated to circle trajectory using Gram-Schmidt calibration process to solve phase and amplitude difference between two channels, DC offset component in IQ signals with circle trajectory is cancelled using circular trajectory fitting method and the IQ signals are demodulated to extract the Doppler phase. Gram-Schmidt calibration process involves complex computation, spends more time, and is unavailable to fully solve distortion caused by severe clutter according to two-channel data.

### SUMMARY OF THE INVENTION

One object of the present invention is to compress four channels of a radar into two sets effective signals through linear combination. Trajectories of the two sets effective signals are ellipses tilted in opposite directions, thus elliptical trajectory calibration can be achieved using simple computation to calibrate DC offset, amplitude imbalance and phase imbalance, thereby recovering the Doppler phase.

A displacement monitoring method based on elliptical trajectory calibration and modified principal component analysis includes the steps of: outputting first to fourth voltage signals with a phase difference with each other from a radar to a computing device, the first to fourth voltage signals have a Doppler phase; linear combining three of the first to fourth voltage signals into first to fourth linear combined voltage signals by the computing device, wherein a first elliptical trajectory is plotted with the first and second linear combined voltage signals and a second elliptical trajectory is plotted with the third and fourth linear combined voltage signals; estimating centers of the first and second elliptical trajectories by the computing device, the computing device is configured to apply a DC offset calibration on the first and second linear combined voltage signals using the center of the first elliptical trajectory to obtain a first DC offset calibrated signal and a second DC offset calibrated signal, and the computing device is configured to apply a DC offset calibration on the third and fourth linear combined voltage signals using the center of the second elliptical trajectory to obtain a third DC offset calibrated signal and a fourth DC offset calibrated signal, wherein a third elliptical trajectory is plotted with the first and second DC offset calibrated signals and a fourth elliptical trajectory is plotted with the third and fourth DC offset calibrated signals; calculating a first minimum bounding box of the third elliptical trajectory and a second minimum bounding box of the fourth elliptical trajectory by the computing device, the computing device is configured to calibrate amplitude imbalance between the first and second DC offset calibrated signals using the first minimum bounding box to obtain a first amplitude imbalance calibrated signal and a second amplitude imbalance calibrated signal, the computing device is configured to calibrate amplitude imbalance between the third and fourth DC offset calibrated signals using the second minimum bounding box to obtain a third amplitude imbalance calibrated signal and a fourth amplitude imbalance calibrated signal, wherein a fifth elliptical trajectory is plotted with the first and second amplitude imbalance calibrated signals and a sixth elliptical trajectory is plotted with the third and fourth amplitude imbalance calibrated signals; rotating the fifth and sixth elliptical trajectories by the computing device, the computing device is configured to calibrate phase imbalance between the first and second amplitude imbalance calibrated signals by rotating the fifth elliptical trajectory to obtain a first phase imbalance calibrated signal and a second phase imbalance calibrated signal, the computing device is configured to calibrate phase imbalance between the third and fourth amplitude imbalance calibrated signals by rotating the sixth elliptical trajectory to obtain a third phase imbalance calibrated signal and a fourth phase imbalance calibrated signal, wherein a seventh elliptical trajectory is plotted with the first and second phase imbalance calibrated signals and an eighth elliptical trajectory is plotted with the third and fourth phase imbalance calibrated signals; calculating a third minimum bounding box of the seventh elliptical trajectory and a fourth minimum bounding box of the eighth elliptical trajectory by the computing device, the computing device is configured to calibrate amplitude imbalance between the first and second phase imbalance calibrated signals using the third minimum bounding box to obtain a fifth amplitude imbalance calibrated signal and a sixth amplitude imbalance calibrated signal, the computing device is configured to calibrate amplitude imbalance between the third and fourth phase imbalance calibrated signals using the fourth minimum bounding box to obtain a seventh amplitude imbalance calibrated signal and an eighth amplitude imbalance calibrated signal; phase demodulating the fifth and sixth amplitude imbalance calibrated signals to obtain a first phase demodulated signal and phase demodulating the seventh and eighth amplitude imbalance calibrated signals to obtain a second phase demodulated signal by the computing device; and combining the first and second phase demodulated signals to recover the Doppler phase by the computing device.

The voltage signals are linear-combined and compressed into two sets signals to avoid null point issue during displacement monitoring. Trajectories of the two sets signals are tilted ellipses with mirror symmetry, hence DC offset, amplitude imbalance and phase imbalance can be calibrated through simple computation, and clutter effect can be cancelled after demodulation of the two sets signals and combination of the demodulated signals. In the present invention, rapid and accurate displacement monitoring is feasible.

### BRIEF DESCRIPTION OF DRAWINGS

FIG. 1 is flow chart illustrating a displacement monitoring method based on elliptical trajectory calibration and modified principal component analysis in accordance with one embodiment of the present invention.

FIG. 2 is a block diagram illustrating a radar and a computing device in accordance with one embodiment of the present invention.

FIG. 3 is a circuit diagram illustrating a radar in accordance with one embodiment of the present invention.

FIG. 4a shows a first elliptical trajectory plotted with first and second linear combined voltage signals in accordance with one embodiment of the present invention.

FIG. 4b shows a second elliptical trajectory plotted with third and fourth linear combined voltage signals in accordance with one embodiment of the present invention.

FIG. 5a shows a third elliptical trajectory plotted with first and second DC offset calibrated signals in accordance with one embodiment of the present invention.

FIG. 5b shows a fourth elliptical trajectory plotted with third and fourth DC offset calibrated signals in accordance with one embodiment of the present invention.

FIG. 6 shows a first minimum bounding box of a third elliptical trajectory plotted with first and second DC offset calibrated signals in accordance with one embodiment of the present invention.

FIG. 7a shows a fifth elliptical trajectory plotted with first and second amplitude imbalance calibrated signals and a seventh elliptical trajectory plotted with first and second phase imbalance calibrated signals in accordance with one embodiment of the present invention.

FIG. 7b shows a sixth elliptical trajectory plotted with third and fourth amplitude imbalance calibrated signals and an eighth elliptical trajectory plotted with third and fourth phase imbalance calibrated signals in accordance with one embodiment of the present invention.

FIG. 8a shows a first circle trajectory plotted with fifth and sixth amplitude imbalance calibrated signals in accordance with one embodiment of the present invention.

FIG. 8b shows a second circle trajectory plotted with seventh and eighth amplitude imbalance calibrated signals in accordance with one embodiment of the present invention.

### DETAILED DESCRIPTION OF THE INVENTION

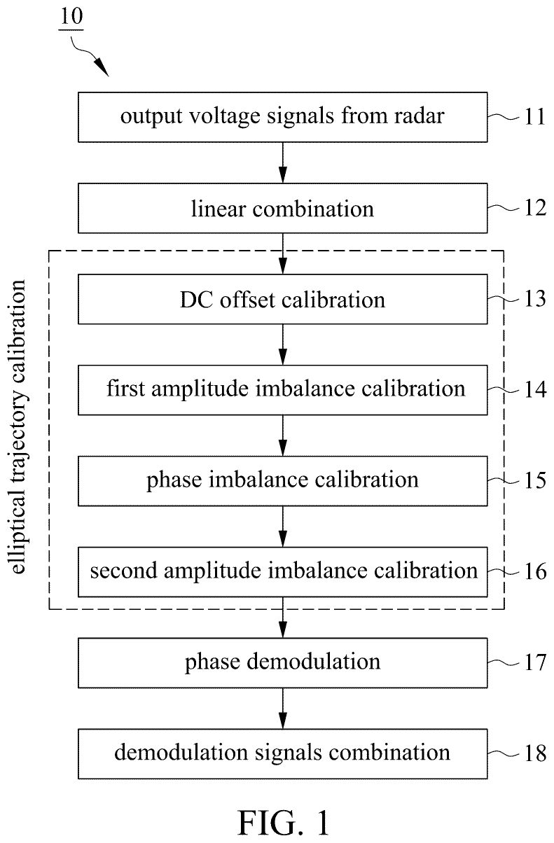

FIG. 1 is the flow chart of a displacement monitoring method 10 based on elliptical trajectory calibration and modified principal component analysis in accordance with one embodiment of the present invention. The displacement monitoring method 10 includes a step 11 of outputting voltage signals from a radar, a step 12 of linear combination, a step 13 of DC offset calibration, a step 14 of first amplitude imbalance calibration, a step 15 of phase imbalance calibration, a step 16 of second amplitude imbalance calibration, a step 17 of phase demodulation and a step 18 of demodulated signals combination. The steps 13 to 16 are the steps for elliptical trajectory calibration.

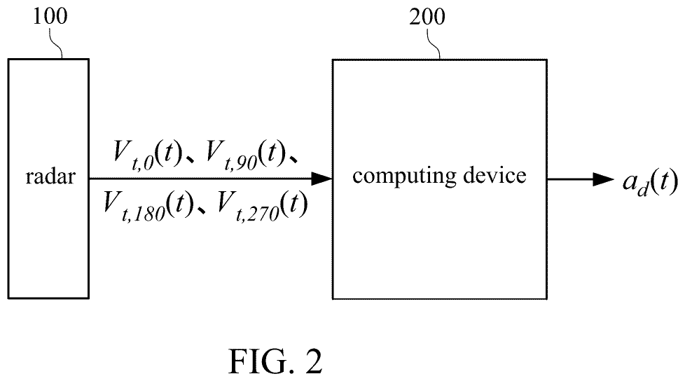

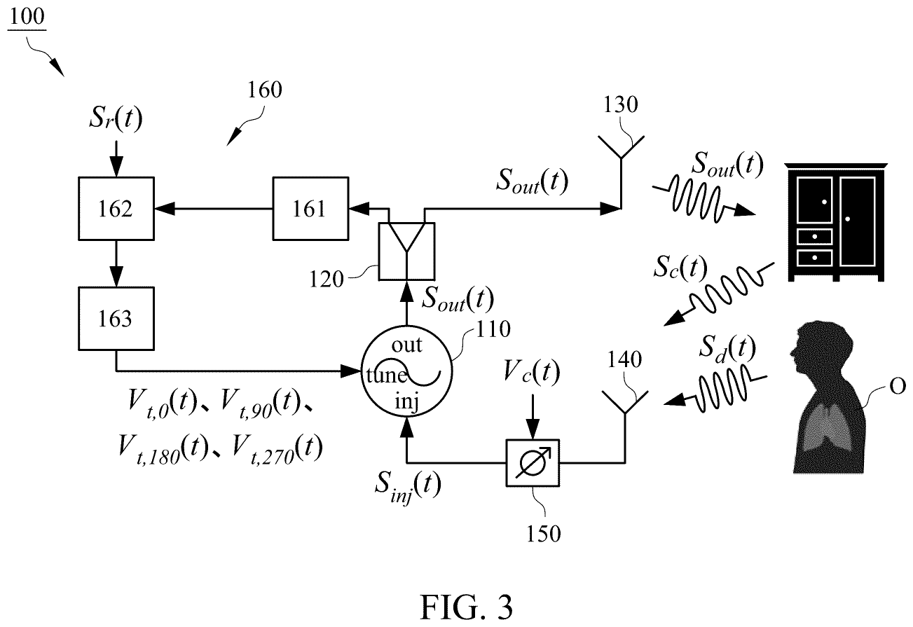

With reference to FIGS. 1 and 2, a radar 100 is provided to output a first voltage signal V_{t,0}(t), a second voltage signal V_{t,90}(t), a third voltage signal V_{t,180}(t) and a fourth voltage signal V_{t,270}(t) to a computing device 200 in the step 11. Referring to FIGS. 2 and 3, the radar 100 is, but not limit to, a phase- and quadrature self-injection-locked radar (PQSIL radar), and the radar 100 may be a Doppler radar or other radar in other embodiments.

With reference to FIG. 3, the radar 100 in this embodiment includes an injection-locked oscillator 110, a power splitter 120, a transmit antenna 130, a receive antenna 140, a phase shifter 150 and a phase-locked loop circuit 160. The injection-locked oscillator 110 produces and output an oscillation signal Sₒᵤₜ(t) via an output port out, the power splitter 120 electrically connected to the injection-locked oscillator 110 receives and splits the oscillation signal Sₒᵤₜ(t) into two paths, the transmit antenna 130 electrically connected to the power splitter 120 receives and transmits the oscillation signal Sₒᵤₜ(t) of one path to a human body O. After transmitting the oscillation signal Sₒᵤₜ(t) to the human body O, a reflected signal S_{d}(t) reflected from the human body O is received by the receive antenna 140. The phase shifter 150 electrically connected to the receive antenna 140 receives the reflected signal S_{d}(t) and a control voltage V_{c}(t), and the phase shifter 150 is controlled by the control voltage V_{c}(t) to adjust the phase of the reflected signal Sa (t) and output an injection signal Sᵢₙⱼ(t). In this embodiment, the phase shifter 150 gives a phase delay of 0, 90, 180 and 270 degrees in the reflected signal S_{d}(t) to obtain the injection signal Sᵢₙⱼ(t) with four different phase delays. The injection signal Sᵢₙⱼ(t) is injected into an injection port inj of the injection-locked oscillator 110 to operate the injection-locked oscillator 110 in injection-locked state. Owing to the Doppler effect caused by the displacement of the human body O, the reflected signal S_{d}(t) contains a Doppler phase associated with the displacement of the human body O, and the oscillation frequency of the injection-locked oscillator 110 is changed according to the Doppler phase while the injection signal Sᵢₙⱼ(t) is injected into and locks the injection-locked oscillator 110. The injection signal Sᵢₙⱼ(t) with four different phase delays is obtained after the phase shifter 150 producing 0, 90, 180 and 270 degrees phase delay in the reflected signal S_{d}(t), thus the oscillation signal Sₒᵤₜ(t) with four phase delays of 0, 90, 180 and 270 degrees is also obtained after the injection signal Sᵢₙⱼ(t) is injected into to lock the injection-locked oscillator 110.

In addition, there may be an object in the environment, the oscillation signal Sₒᵤₜ(t) from the transmit antenna 130 is also transmitted to the object, e.g. the cabinet shown in FIG. 3, and a clutter signal S_{c}(t) is reflected from the object and received by the receive antenna 140. The clutter signal S_{c}(t) is delivered to the phase shifter 150, a phase delay of 0, 90, 180 and 270 degrees is given in the clutter signal S_{c}(t) by the phase shifter 150, and the injection signal Sᵢₙⱼ(t) having the phase delay is injected into the injection-locked oscillator 110.

With reference to FIG. 3, the phase-locked loop circuit 160 includes a frequency divider 161, a phase-frequency discriminator 162 and a loop filter 163. The frequency divider 161 electrically connected to the power splitter 120 receives the oscillation signal Sₒᵤₜ(t) of the other path, divides the frequency of the oscillation signal Sₒᵤₜ(t) and deliver the divided oscillation signal Sₒᵤₜ(t) to the phase-frequency discriminator 162. The divided oscillation signal Sₒᵤₜ(t) is compared with the reference signal Sᵣ(t) in phase and frequency by the phase-frequency discriminator 162 and filtered by the loop filter 163. The first to fourth voltage signals V_{t,0}(t), V_{t,90}(t), V_{t,180}(t) and V_{t,270}(t) are output from the loop filter 163 and delivered to a tune port tune of the injection-locked oscillator 110 to form a phase-locked loop. The phase-locked loop circuit 160 is provided to stable the oscillation frequency of the injection-locked oscillator 110. The first to fourth voltage signals V_{t,0}(t), V_{t,90}(t), V_{t,180}(t) and V_{t,270}(t) have a phase difference between each other, preferably, the phase difference between the first and second voltage signals V_{t,0}(t) and V_{t,90}(t) is 90 degrees, the phase difference between the second and third voltage signals V_{t,90}(t) and V_{t,180}(t) is 90 degrees, the phase difference between the third and fourth voltage signals V_{t,180}(t) and V_{t,270}(t) is 90 degrees. The phase differences of 90 degrees can simplify subsequent computations.

The injection-locked oscillator 110 may suffer output frequency shift problem as being injection-locked by the injection signal Sᵢₙⱼ(t), but the first to fourth voltage signals V_{t,0}(t), V_{t,90}(t), V_{t,180}(t) and V_{t,270}(t) outputting from the phase-locked loop circuit 160 can stable the output frequency of the injection-locked oscillator 110 automatically. As a result, the first to fourth voltage signals V_{t,0}(t), V_{t,90}(t), V_{t,180}(t) and V_{t,270}(t) from the phase-locked loop circuit 160 contain the Doppler phase caused by the displacement of the human body O, and the Doppler phase can be obtained from four-channel data. The first to fourth voltage signals V_{t,0}(t), V_{t,90}(t), V_{t,180}(t) and V_{t,270}(t) can be expressed as

$${V}_{t , 0} ( t ) = {V}_{i} + \frac{{ω}_{LR , c}}{{K}_{v}} sin {α}_{c} ( t ) + \frac{{ω}_{LR , d}}{{K}_{v}} {C}_{0} ( t ) sin {α}_{d} ( t ) ,$$

$${V}_{t , 90} ( t ) = {V}_{i} - \frac{{ω}_{LR , c}}{{K}_{v}} cos {α}_{c} ( t ) - \frac{{ω}_{LR , d}}{{K}_{v}} {C}_{90} ( t ) cos {α}_{d} ( t ) ,$$

$${V}_{t , 180} ( t ) = {V}_{i} - \frac{{ω}_{LR , c}}{{K}_{v}} sin {α}_{c} ( t ) - \frac{{ω}_{LR , d}}{{K}_{v}} {C}_{180} ( t ) sin {α}_{d} ( t ) ,$$

$${V}_{t , 270} ( t ) = {V}_{i} + \frac{{ω}_{LR , c}}{{K}_{v}} cos {α}_{c} ( t ) + \frac{{ω}_{LR , d}}{{K}_{v}} {C}_{270} ( t ) cos {α}_{d} ( t ) ,$$

where Vᵢ and Kᵥ are the initial voltage and the tuning sensitivity of the injection-locked oscillator 110, ω_{LR,c} is the locking range of the clutter signal S_{c}(t), ω_{LR,d} is the locking range of the reflected signal S_{d}(t), α_{c}(t) is the phase difference of the clutter signal S_{c}(t), α_{d}(t) is the Doppler phase of the reflected signal S_{d}(t), C₀(t), C₉₀(t), C₁₈₀(t) and C₂₇₀(t) are correction terms of the four channels and can be given as

$$\{ \begin{matrix}{C}_{0} ( t ) = 1 - ( {E}_{c} / {E}_{osc} ) \cdot cos {α}_{c} ( t ) \\ {C}_{90} ( t ) = 1 - ( {E}_{c} / {E}_{osc} ) \cdot sin {α}_{c} ( t ) \\ {C}_{180} ( t ) = 1 + ( {E}_{c} / {E}_{osc} ) \cdot cos {α}_{c} ( t ) \\ {C}_{270} ( t ) = 1 + ( {E}_{c} / {E}_{osc} ) \cdot sin {α}_{c} ( t )\end{matrix} ,$$

where E_{c} denotes the amplitude of the clutter signal S_{c}(t), and E_{osc} denotes the amplitude of the oscillation signal Sₒᵤₜ(t).

With reference to FIGS. 1 and 2, the computing device 200 linear combines three of the first to fourth voltage signals V_{t,0}(t), V_{t,90}(t), V_{t,180}(t) and V_{t,270}(t) into first to fourth linear combined voltage signals V_{A1}(t), V_{A2}(t), V_{B1}(t) and V_{B2}(t), respectively, in the step 12. In this embodiment, the first and third linear combined voltage signals V_{A1}(t) and V_{B1}(t) are derived from the linear combinations of the first to third voltage signals V_{t,0}(t), V_{t,90}(t) and V_{t,180}(t), the second and fourth linear combined voltage signals V_{A2}(t) and V_{B2}(t) are derived from the linear combinations of the second to fourth voltage signals V_{t,90}(t), V_{t,180}(t) and V_{t,270}(t). The first to fourth linear combined voltage signals V_{A1}(t), V_{A2}(t), V_{B1}(t) and V_{B2}(t) are given as

$${V}_{A 1} ( t ) = {V}_{t , 0} ( t ) + 2 {V}_{t , 90} ( t ) - {V}_{t , 180} ( t ) = 2 {V}_{i} + 2 \frac{{ω}_{LR , c}}{{K}_{v}} \sqrt{2} sin ( {α}_{c} ( t ) - 45 ° ) + 2 \frac{{ω}_{LR , d}}{{K}_{v}} \sqrt{1 + {C}_{90}^{2} ( t )} sin ( {α}_{d} ( t ) - {θ}_{1} ( t ) ) ,$$

$${V}_{A 2} ( t ) = {V}_{t , 90} ( t ) - 2 {V}_{t , 180} ( t ) + {V}_{t , 270} ( t ) = 2 \frac{{ω}_{LR , c}}{{K}_{v}} sin {α}_{c} ( t ) + 2 \frac{{ω}_{LR , d}}{{K}_{v}} \sqrt{{C}_{180}^{2} ( t ) + {( 1 - {C}_{90} ( t ) )}^{2}} sin ( {α}_{d} ( t ) + {θ}_{2} ( t ) ) ,$$

$${V}_{B 1} ( t ) = {V}_{t , 0} ( t ) - 2 {V}_{t , 90} ( t ) - {V}_{t , 180} ( t ) = - 2 {V}_{i} + 2 \frac{{ω}_{LR , c}}{{K}_{v}} \sqrt{2} sin ( {α}_{c} ( t ) + 45 ° ) + 2 \frac{{ω}_{LR , d}}{{K}_{v}} \sqrt{1 + {C}_{90}^{2} ( t )} sin ( {α}_{d} ( t ) + {θ}_{1} ( t ) ) ,$$

$${V}_{B 2} ( t ) = {V}_{t , 90} ( t ) + 2 {V}_{t , 180} ( t ) + {V}_{t , 270} ( t ) = 4 {V}_{i} - 2 \frac{{ω}_{LR , c}}{{K}_{v}} sin {α}_{c} ( t ) - 2 \frac{{ω}_{LR , d}}{{K}_{v}} \sqrt{{C}_{180}^{2} ( t ) + {( 1 - {C}_{90} ( t ) )}^{2}} sin ( {α}_{d} ( t ) - {θ}_{2} ( t ) ) ,$$

$$where$$

$${θ}_{1} ( t ) = {tan}^{- 1} {C}_{90} ( t ) , {θ}_{2} ( t ) = {tan}^{- 1} [ ( 1 - {C}_{90} ( t ) ) / {C}_{180} ( t ) ] .$$

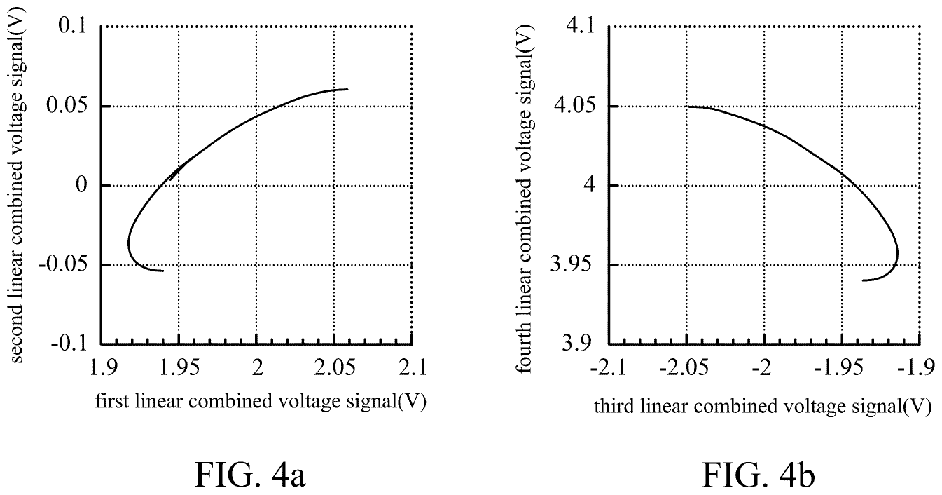

As known from the aforementioned equations, in the linear combinations of the first and third linear combined voltage signals V_{A1}(t) and V_{B1}(t), the first and third voltage signals V_{t,0}(t) and V_{t,180}(t) have the same coefficient and the same plus-minus sign and the second voltage signal V_{t,90}(t) has the same coefficient and different plus-minus signs. And in the linear combinations of the second and fourth linear combined voltage signals V_{A2}(t) and V_{B2}(t), the second and fourth voltage signals V_{t,90}(t) and V_{t,270}(t) have the same coefficient and the same plus-minus sign and the third voltage signal V_{t,180}(t) has the same coefficient and different plus-minus signs. The linear combinations can compress three channels with three different phase delays into an effective channel without null-point issue and clutter effect. A first elliptical trajectory plotted with the first and second linear combined voltage signals V_{A1}(t) and V_{A2}(t) is shown in FIG. 4a, and a second elliptical trajectory plotted with the third and fourth linear combined voltage signals V_{B1}(t) and V_{B2}(t) is shown in FIG. 4b. As shown in FIGS. 4a and 4b, the first and second elliptical trajectories are a right-tilt and left-tile ellipse, respectively, and provided for simplifying the following calibration processing.

With reference to FIGS. 1 and 2, the computing device 200 estimates centers of the first and second elliptical trajectories in the step 13. The computing device 200 applies a DC offset calibration on the first and second linear combined voltage signals V_{A1}(t) and V_{A2}(t) using the center of the first elliptical trajectory to obtain first and second DC offset calibrated signals V_{A1,r1}(t) and V_{A2,r1}(t), and the computing device 200 applies a DC offset calibration on the third and fourth linear combined voltage signals V_{B1}(t) and V_{B2}(t) using the center of the second elliptical trajectory to obtain third and fourth DC offset calibrated signals. Preferably, ellipse fitting is applied to the first and second linear combined voltage signals V_{A1}(t) and V_{A2}(t) to determine the center of the first elliptical trajectory and applied to the third and fourth linear combined voltage signals V_{B1}(t) and V_{B2}(t) to determine the center of the second elliptical trajectory. DC offset causes the centers of the first and second elliptical trajectories to be not located at the origin (0,0), the computing device 200 minus the center value of the first elliptical trajectory in the first and second linear combined voltage signals V_{A1}(t) and V_{A2}(t) and minus the center value of the second elliptical trajectory in the third and fourth linear combined voltage signals V_{B1}(t) and V_{B2}(t), thus the DC offset can be calibrated by moving the centers of the first and second elliptical trajectories to the origin. The first and second DC offset calibrated signals V_{A1,r1}(t) and V_{A2,r1}(t) can be derived as

$$\{ \begin{matrix}{V}_{A 1 , r 1} ( t ) = 2 \frac{{ω}_{LR , d}}{{K}_{v}} \sqrt{1 + {{C}_{90} ( t )}^{2}} sin ( {α}_{d} ( t ) - {θ}_{1} ( t ) ) \\ {V}_{A 2 , r 1} ( t ) = 2 \frac{{ω}_{LR , d}}{{K}_{v}} \sqrt{{{C}_{180} ( t )}^{2} + {( 1 - {C}_{90} ( t ) )}^{2}} sin ( {α}_{d} ( t ) + {θ}_{2} ( t ) )\end{matrix} .$$

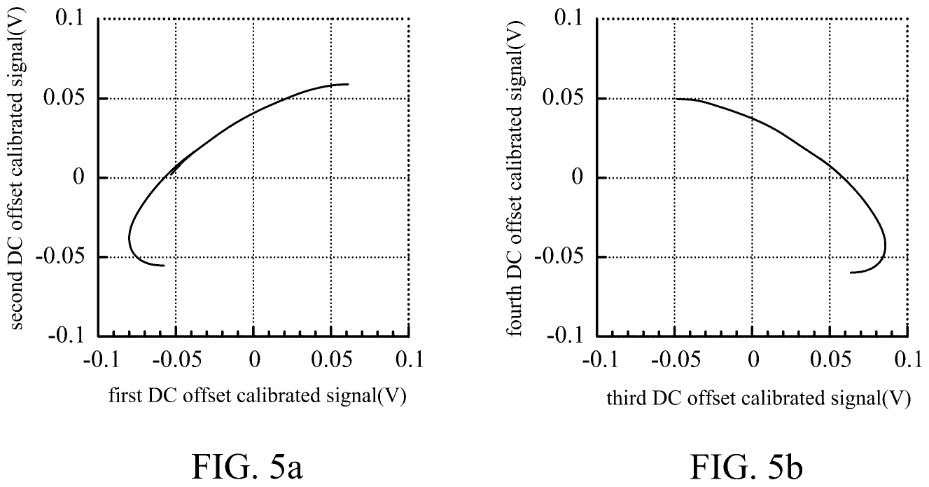

The equations of the third and fourth DC offset calibrated signals are similar to that of the first and second DC offset calibrated signals V_{A1,r1}(t) and V_{A2,r1}(t) so there is no more detailed description. A third elliptical trajectory plotted with the first and second DC offset calibrated signals V_{A1,r1}(t) and V_{A2,r1}(t) is shown in FIG. 5a, and a fourth elliptical trajectory plotted with the third and fourth DC offset calibrated signals is shown in FIG. 5b. The DC offset calibration results show the centers of the third and fourth elliptical trajectories are moved to the origin.

With reference to FIGS. 1 and 2, the computing device 200 calculates a first minimum bounding box of the third elliptical trajectory and a second minimum bounding box of the fourth elliptical trajectory in the step 14. The amplitude imbalance between the first and second DC offset calibrated signals V_{A1,r1}(t) and V_{A2,r1}(t) is calibrated according to the first minimum bounding box to obtain first and second amplitude imbalance calibrated signals V_{A1,r2}(t) and V_{A2,r2}(t), and the amplitude imbalance between the third and fourth DC offset calibrated signals is calibrated according to the second minimum bounding box to obtain third and fourth amplitude imbalance calibrated signals.

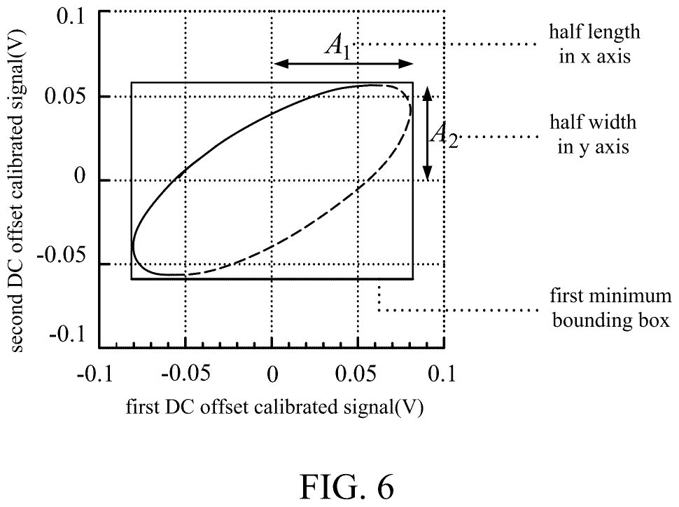

Calculation of the first minimum bounding box for the third elliptical trajectory presents in FIG. 6. As shown in FIG. 6, the third elliptical trajectory have different amplitude values in x and y axis, and the amplitude imbalance between the first and second DC offset calibrated signals V_{A1,r1}(t) and V_{A2,r1}(t) can be calibrated by dividing a half length A₁ in x axis and a half width A₂ in y axis of the first minimum bounding box to obtain the first and second amplitude imbalance calibrated signals V_{A1,r2}(t) and V_{A2,r2}(t). Consequently, the bounding box of the third elliptical trajectory is modified to be a square with a length to width ratio of 1:1 to calibrate the amplitude imbalance. The first and second amplitude imbalance calibrated signals V_{A1,r2}(t) and V_{A2,r2}(t) are given as

$$\{ \begin{matrix}{V}_{A 1 , r 2} ( t ) = sin ( {α}_{d} ( t ) - {θ}_{1} ( t ) ) \\ {V}_{A 2 , r 2} ( t ) = sin ( {α}_{d} ( t ) + {θ}_{2} ( t ) )\end{matrix} .$$

Also, the third and fourth DC offset calibrated signals are calibrated to obtain the third and fourth amplitude imbalance calibrated signals by dividing a half length in x axis and a half width in y axis of the second minimum bounding box of the fourth elliptical trajectory.

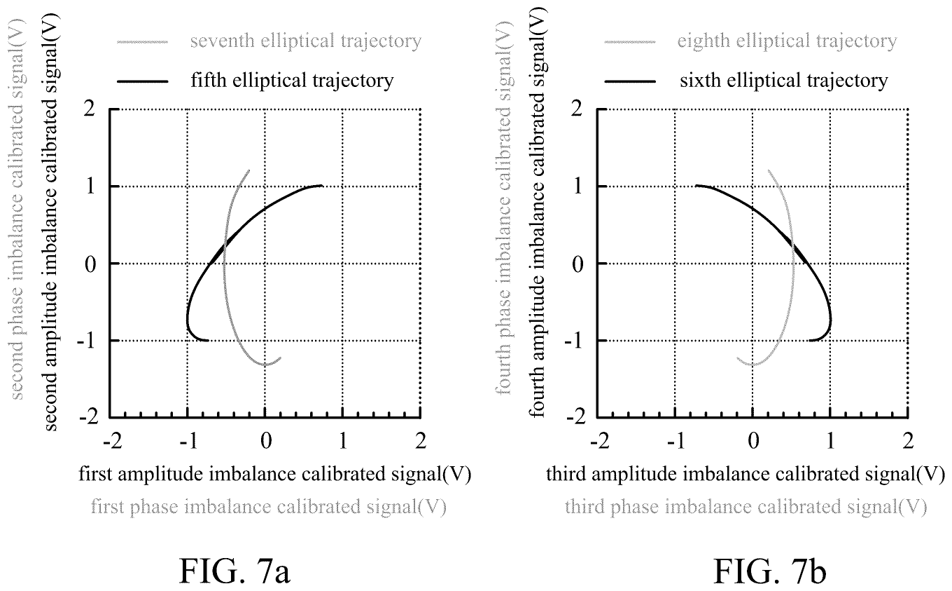

A fifth elliptical trajectory plotted with the first and second amplitude imbalance calibrated signals is presented in the black line of FIG. 7a, and a sixth elliptical trajectory plotted with the third and fourth amplitude imbalance calibrated signals are presented in the black line of FIG. 7b. As shown in FIGS. 7a and 7b, amplitudes of the fifth and sixth elliptical trajectories in x and y axis are equal, indicating that amplitude imbalance is calibrated.

With reference to FIGS. 1 and 2, in the step 15, the computing device 200 rotates the fifth elliptical trajectory to calibrate phase imbalance between the first and second amplitude imbalance calibrated signals V_{A1,r2}(t) and V_{A2,r2}(t) to obtain first and second phase imbalance calibrated signals V_{A1,r3}(t) and V_{A2,r3}(t), and the computing device 200 rotates the sixth elliptical trajectory to calibrate phase imbalance between the third and fourth amplitude imbalance calibrated signals to obtain third and fourth phase imbalance calibrated signals. The fifth elliptical trajectory plotted in the black line of FIG. 7a is a right-tilt ellipse and the sixth elliptical trajectory plotted in the black line of FIG. 7b is a left-tilt ellipse, the computing device 200 anticlockwise rotates the tilt ellipses with 45 degrees using a first rotation matrix to calibrate the phase imbalance between the first and second amplitude imbalance calibrated signals V_{A1,r2}(t) and V_{A2,r2}(t) to obtain the first and second phase imbalance calibrated signals V_{A1,r3}(t) and V_{A2,r3}(t). The rotated result can be expressed as

$$[ \begin{matrix}{V}_{A 1 , r 3} ( t ) \\ {V}_{A 2 , r 3} ( t )\end{matrix} ] = [ \begin{matrix}cos {θ}_{A} & - sin {θ}_{A} \\ sin {θ}_{A} & cos {θ}_{A}\end{matrix} ] [ \begin{matrix}{V}_{A 1 , r 2} ( t ) \\ {V}_{A 2 , r 2} ( t )\end{matrix} ] ,$$

where θ_{A} is the rotation angle, and the first and second phase imbalance calibrated signals V_{A1,r3}(t) and V_{A2,r3}(t) can be simplified as

$$\{ \begin{matrix}{V}_{A 1 , r 3} ( t ) = \sqrt{2} sin ( \frac{- {θ}_{1} ( t ) - {θ}_{2} ( t )}{2} ) cos ( {α}_{d} ( t ) + \frac{- {θ}_{1} ( t ) + {θ}_{2} ( t )}{2} ) \\ {V}_{A 2 , r 3} ( t ) = \sqrt{2} cos ( \frac{- {θ}_{1} ( t ) - {θ}_{2} ( t )}{2} ) sin ( {α}_{d} ( t ) + \frac{- {θ}_{1} ( t ) + {θ}_{2} ( t )}{2} )\end{matrix} .$$

Similarly, the computing device 200 clockwise rotates the tilt ellipses with 45 degrees using a second rotation matrix to calibrate the phase imbalance between the third and fourth amplitude imbalance calibrated signals and obtain the third and fourth phase imbalance calibrated signals. Rotation direction of the first rotation matrix is opposite to that of the second rotation matrix due to the fifth and sixth elliptical trajectories are tilted toward different directions. A seventh elliptical trajectory plotted with the first and second phase imbalance calibrated signals V_{A1,r3}(t) and V_{A2,r3}(t) is shown as the gray line of FIG. 7a, and an eighth elliptical trajectory plotted with the third and fourth phase imbalance calibrated signals are shown as the gray line of FIG. 7b. The rotated seventh and eighth elliptical trajectories are ellipses with no tilt angle, indicating that the phase imbalance is calibrated.

With reference to FIGS. 1 and 2, the computing device 200 calculates a third minimum bounding box of the seventh elliptical trajectory and a fourth minimum bounding box of the eighth elliptical trajectory in the step 16. The computing device 200 uses the third minimum bounding box to calibrate the amplitude imbalance between the first and second phase imbalance calibrated signals V_{A1,r3}(t) and V_{A2,r3}(t) and obtain fifth and sixth amplitude imbalance calibrated signals V_{A1,r4}(t) and V_{A2,r4}(t). And the computing device 200 uses the fourth minimum bounding box to calibrate the amplitude imbalance between the third and fourth phase imbalance calibrated signals and obtain seventh and eighth amplitude imbalance calibrated signals.

With reference to FIGS. 7a and 7b, the rotated seventh and eighth elliptical trajectories have unequal amplitudes in x and y axis, thus the first and second phase imbalance calibrated signals V_{A1,r3}(t) and V_{A2,r3}(t) are calibrated by dividing a half length in x axis and a half width in y axis of the third minimum bounding box to obtain the fifth and sixth amplitude imbalance calibrated signals V_{A1,r4}(t) and V_{A2,r4}(t) which are derived as

$$\{ \begin{matrix}{V}_{A 1 , r 4} ( t ) = cos ( {α}_{d} ( t ) + \frac{- {θ}_{1} ( t ) + {θ}_{2} ( t )}{2} ) \\ {V}_{A 2 , r 4} ( t ) = sin ( {α}_{d} ( t ) + \frac{- {θ}_{1} ( t ) + {θ}_{2} ( t )}{2} )\end{matrix} .$$

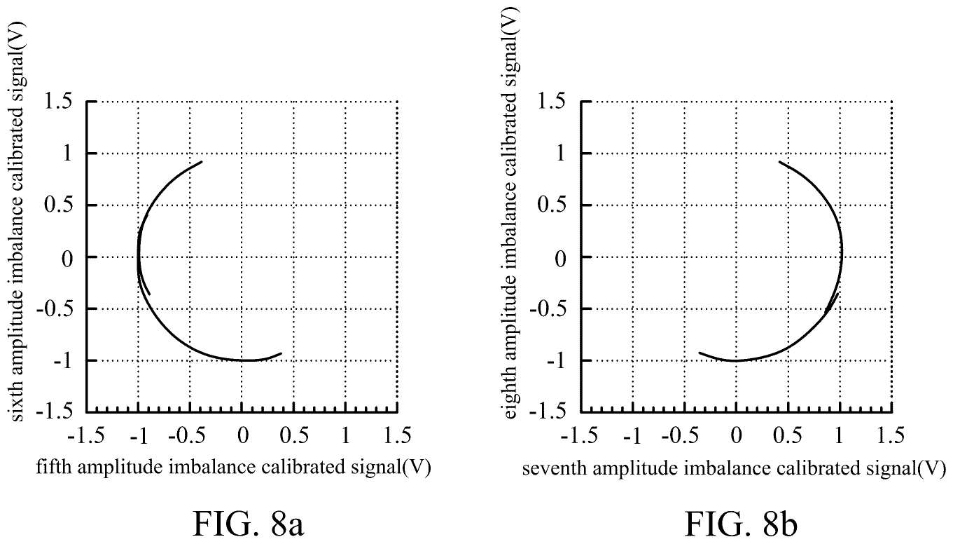

Likewise, the third and fourth phase imbalance calibrated signals are calibrated by dividing a half length in x axis and a half width in y axis of the fourth minimum bounding box to obtain the seventh and eighth amplitude imbalance calibrated signals. A first circle trajectory plotted with the fifth and sixth amplitude imbalance calibrated signals V_{A1,r4}(t) and V_{A2,r4}(t) is shown in FIG. 8a, and a second circle trajectory plotted with the seventh and eighth amplitude imbalance calibrated signals is shown in FIG. 8b. The first and second circle trajectories have the same amplitude in x and y axis, that is, amplitude balance is achieved. Furthermore, centers of the first and second circle trajectories are located at the origin (0,0), indicating DC offset, amplitude imbalance and phase imbalance between each other are eliminated.

With reference to FIG. 1, the computing device 200 phase-demodulates the fifth and sixth amplitude imbalance calibrated signals V_{A1,r4}(t) and V_{A2,r4}(t) to obtain a first phase demodulated signal S_{A}(t) and phase-demodulates the seventh and eighth amplitude imbalance calibrated signals to obtain a second phase demodulated signal S_{B}(t). In this embodiment, the first phase demodulated signal S_{A}(t) is obtained by applying a arctangent demodulation to the fifth and sixth amplitude imbalance calibrated signals V_{A1,r4}(t) and V_{A2,r4}(t), and the second phase demodulated signal S_{B}(t) is obtained by applying a arctangent demodulation to the seventh and eighth amplitude imbalance calibrated signals. The first and second phase demodulated signals S_{A}(t) and S_{B}(t) can be expressed as

$${S}_{A} ( t ) = {tan}^{- 1} [ \frac{{V}_{A 2 , r 4} ( t )}{{V}_{A 1 , r 4} ( t )} ] = {α}_{d} ( t ) + \frac{- {θ}_{1} ( t ) + {θ}_{2} ( t )}{2} ,$$

$${S}_{B} ( t ) = {tan}^{- 1} [ \frac{{V}_{B 2 , r 4} ( t )}{{V}_{B 1 , r 4} ( t )} ] = {α}_{d} ( t ) + \frac{{θ}_{1} ( t ) - {θ}_{2} ( t )}{2} .$$

And channel correction terms θ₁(t) and θ₂(t) still can be seen in the first and second phase demodulated signals S_{A}(t) and S_{B}(t).

With reference to FIG. 1, the computing device 200 combines the first and second phase demodulated signals S_{A}(t) and S_{B}(t) to recover the Doppler phase in the step 18. As shown in the aforementioned two equations, the correction terms of the first and second phase demodulated signals S_{A}(t) and S_{B}(t) have different plus-minus signs and can be eliminated after adding the first and second phase demodulated signals S_{A}(t) and S_{B}(t) together. In this embodiment, the first and second phase demodulated signals S_{A}(t) and S_{B}(t) are added together and divided equally by the computing device 200 to get a radar phase demodulated signal. Accordingly, the residual clutter can be eliminated to obtain a clear Doppler phase and recover the object's displacement accurately.

In the present invention, linear combination is used to compress the four voltages into two sets linear combined voltage signals to prevent null-point issue and reduce clutter effect. Due to the trajectories of the linear combined voltage signals are tilted ellipses with mirror symmetry, DC offset, amplitude imbalance and phase imbalance can be calibrated through simple computation, and the calibrated signals can be demodulated and combined to completely eliminate clutter effect. Consequently, a rapid and accurate displacement monitoring method is proposed in the present invention.

The scope of the present invention is only limited by the following claims. Any alternation and modification without departing from the scope and spirit of the present invention will become apparent to those skilled in the art.

1. A displacement monitoring method comprising the steps of:
outputting first to fourth voltage signals with a phase difference with each other from a radar to a computing device, the first to fourth voltage signals have a Doppler phase;
linear combining three of the first to fourth voltage signals into first to fourth linear combined voltage signals by the computing device, wherein a first elliptical trajectory is plotted with the first and second linear combined voltage signals and a second elliptical trajectory is plotted with the third and fourth linear combined voltage signals;
estimating centers of the first and second elliptical trajectories by the computing device, the computing device is configured to apply a DC offset calibration on the first and second linear combined voltage signals using the center of the first elliptical trajectory to obtain a first DC offset calibrated signal and a second DC offset calibrated signal, and the computing device is configured to apply a DC offset calibration on the third and fourth linear combined voltage signals using the center of the second elliptical trajectory to obtain a third DC offset calibrated signal and a fourth DC offset calibrated signal, wherein a third elliptical trajectory is plotted with the first and second DC offset calibrated signals and a fourth elliptical trajectory is plotted with the third and fourth DC offset calibrated signals;
calculating a first minimum bounding box of the third elliptical trajectory and a second minimum bounding box of the fourth elliptical trajectory by the computing device, the computing device is configured to calibrate amplitude imbalance between the first and second DC offset calibrated signals using the first minimum bounding box to obtain a first amplitude imbalance calibrated signal and a second amplitude imbalance calibrated signal, the computing device is configured to calibrate amplitude imbalance between the third and fourth DC offset calibrated signals using the second minimum bounding box to obtain a third amplitude imbalance calibrated signal and a fourth amplitude imbalance calibrated signal, wherein a fifth elliptical trajectory is plotted with the first and second amplitude imbalance calibrated signals and a sixth elliptical trajectory is plotted with the third and fourth amplitude imbalance calibrated signals;
rotating the fifth and sixth elliptical trajectories by the computing device, the computing device is configured to calibrate phase imbalance between the first and second amplitude imbalance calibrated signals by rotating the fifth elliptical trajectory to obtain a first phase imbalance calibrated signal and a second phase imbalance calibrated signal, the computing device is configured to calibrate phase imbalance between the third and fourth amplitude imbalance calibrated signals by rotating the sixth elliptical trajectory to obtain a third phase imbalance calibrated signal and a fourth phase imbalance calibrated signal, wherein a seventh elliptical trajectory is plotted with the first and second phase imbalance calibrated signals and an eighth elliptical trajectory is plotted with the third and fourth phase imbalance calibrated signals;
calculating a third minimum bounding box of the seventh elliptical trajectory and a fourth minimum bounding box of the eighth elliptical trajectory by the computing device, the computing device is configured to calibrate amplitude imbalance between the first and second phase imbalance calibrated signals using the third minimum bounding box to obtain a fifth amplitude imbalance calibrated signal and a sixth amplitude imbalance calibrated signal, the computing device is configured to calibrate amplitude imbalance between the third and fourth phase imbalance calibrated signals using the fourth minimum bounding box to obtain a seventh amplitude imbalance calibrated signal and an eighth amplitude imbalance calibrated signal;
phase demodulating the fifth and sixth amplitude imbalance calibrated signals to obtain a first phase demodulated signal and phase demodulating the seventh and eighth amplitude imbalance calibrated signals to obtain a second phase demodulated signal by the computing device; and
combining the first and second phase demodulated signals to recover the Doppler phase by the computing device.

2. The displacement monitoring method in accordance with claim 1, wherein a phase difference between the first and second voltage signals is 90 degrees, a phase difference between the second and third voltage signals is 90 degrees, and a phase difference between the third and fourth voltage signals is 90 degrees.

3. The displacement monitoring method accordance with claim 2, wherein the computing device is configured to linear combine the first to third voltage signals into the first and third linear combined voltage signals, and the computing device is configured to linear combine the second to fourth voltage signals into the second and fourth linear combined voltage signals.

4. The displacement monitoring method in accordance with claim 3, wherein the first and third voltage signals have the same coefficient and the same plus-minus sign in linear combinations of the first and third linear combined voltage signals, the second voltage signal has the same coefficient and different plus-minus signs in linear combinations of the first and third linear combined voltage signals, the second and fourth voltage signals have the same coefficient and the same plus-minus sign in linear combinations of the second and fourth linear combined voltage signals, the third voltage signal has the same coefficient and different plus-minus signs in linear combinations of the second and fourth linear combined voltage signals.

5. The displacement monitoring method in accordance with claim 1, wherein the computing device is configured to apply ellipse fitting to the first and second linear combined voltage signals to estimate a center of the first elliptical trajectory and apply ellipse fitting to the third and fourth linear combined voltage signals to estimate a center of the second elliptical trajectory.

6. The displacement monitoring method in accordance with claim 1, wherein the first and second DC offset calibrated signals are calibrated by dividing a half length in x axis and a half width in y axis of the first minimum bounding box of the third elliptical trajectory to obtain the first and second amplitude imbalance calibrated signals, and the third and fourth DC offset calibrated signals are calibrated by dividing a half length in x axis and a half width in y axis of the second minimum bounding box of the fourth elliptical trajectory to obtain the third and fourth amplitude imbalance calibrated signals.

7. The displacement monitoring method in accordance with claim 1, wherein the computing device is configured to rotate the first and second amplitude imbalance calibrated signals with an angle of 45 degrees using a first rotation matrix to obtain the first and second phase imbalance calibrated signals, and the computing device is configured to rotate the third and fourth amplitude imbalance calibrated signals with an angle of 45 degrees using a second rotation matrix to obtain the third and fourth phase imbalance calibrated signals, rotation directions of the first and second rotation matrixes are opposite.

8. The displacement monitoring method in accordance with claim 1, wherein the first and second phase imbalance calibrated signals are calibrated by dividing a half length in x axis and a half width in y axis of the third minimum bounding box of the seventh elliptical trajectory to obtain the fifth and sixth amplitude imbalance calibrated signals, and the third and fourth phase imbalance calibrated signals are calibrated by dividing a half length in x axis and a half width in y axis of the fourth minimum bounding box of the eighth elliptical trajectory to obtain the seventh and eighth amplitude imbalance calibrated signals.

9. The displacement monitoring method in accordance with claim 1, wherein the computing device is configured to arctangent-demodulate the fifth and sixth amplitude imbalance calibrated signals to obtain the first phase demodulated signal, and the computing device is configured to arctangent-demodulate the seventh and eighth amplitude imbalance calibrated signals to obtain the second phase demodulated signal.

10. The displacement monitoring method in accordance with claim 1, wherein the first and second phase demodulated signals are added together and divided by two to obtain a radar phase demodulated signal and recover the Doppler phase.
